(19) United States
(12) Patent Application Publication
(10) Pub. No.: US 2022/0287474 A1
(43) Pub. Date: Sep. 15, 2022

(54) BED WITH TEMPERATURE ADJUSTMENTS

(71) Applicant: Nisco Co., Ltd, Rugao (CN)

(72) Inventors: Wei Wang, Rugao (CN); Jian Xie, Rugao (CN)

(21) Appl. No.: 17/693,554

(22) Filed: Mar. 14, 2022

Related U.S. Application Data
(60) Provisional application No. 63/167,680, filed on Mar. 30, 2021.

(30) Foreign Application Priority Data
Mar. 15, 2021 (CN) 202120532852.0

(51) Int. Cl. A47C 21/04; A47C 31/00; A47C 20/04; H05B 1/02; G01K 1/02

(52) U.S. Cl. CPC A47C 21/048; A47C 31/008; A47C 21/042; A47C 20/04; H05B 1/0272; G01K 1/026; H05B 2203/015

(57) ABSTRACT

A bed includes a mattress; a heating member coupled to the mattress and configured to operably generate heat for the mattress; a temperature detector disposed on the mattress for detecting temperature of the mattress; and a controller coupled with the heating member and the temperature detector and configured to receive and process signals of the temperature detected from the temperature detector and control operations of the heating member based on the temperature signals.

### CROSS-REFERENCE TO RELATED PATENT APPLICATIONS

This application claims priority to and the benefit of U.S. Provisional Patent Application No. 63/167,680, filed Mar. 30, 2021, which is incorporated herein in its entirety by reference.

This application also claims priority to and the benefit of Chinese Patent Application No. 202120532852.0, filed Mar. 15, 2021, which is incorporated herein in its entirety by reference.

### FIELD OF THE INVENTION

The invention generally relates to a bed, and more particular to a bed with temperature adjustments

### BACKGROUND OF THE INVENTION

Sleep is critical for people in every aspect of their lives. Beds are necessary furniture for people to sleep on. Thus, it would be beneficial and desirable for people to have a bed system with temperature adjustment at user's preference so that the user achieves maximum comfort when using the bed system.

### SUMMARY OF THE INVENTION

One of the objectives of this invention relates a bed with temperature adjustment, which solves the problem that a mattress in the prior art does not have a temperature detection unit or a detection unit, but it brings users of discomfort.

In one aspect, the invention relates a bed comprising a mattress; a heating member coupled to the mattress and configured to operably generate heat for the mattress; a temperature detector disposed on the mattress for detecting temperature of the mattress; and a controller coupled with the heating member and the temperature detector and configured to receive and process signals of the temperature detected from the temperature detector and control operations of the heating member based on the temperature signals.

In one embodiment, the heating member comprises one or more heating wires embedded in the mattress.

In one embodiment, the one or more heating wires are flexible, serpentine metal wires.

In one embodiment, the temperature detector comprises one or more of thermocouples, RTDs resistance temperature detectors (RTDs), thermistors, and semiconductor based integrated circuits (IC).

In one embodiment, the temperature detector comprises a flexible cable including a plurality of conductive wires and at least one electrical insulating layer wrapping each of the plurality of conductive wires; and a plurality of sheet-shaped temperature sensors, wherein each temperature sensor is located between a pair of adjacent conductive wires in the flexible cable and is electrically coupled to the pair of adjacent conductive wires.

In one embodiment, each temperature sensor is arranged in the at least one electrical insulating layer.

In one embodiment, the plurality of sheet-shaped temperature sensors is arranged along a width direction of the mattress.

In one embodiment, the temperature detector is assembled in a flexible pad. In one embodiment, the controller comprises a microcontroller unit (MCU) configured to receive and process signals of the temperature detected from the temperature detector and control operations of the heating member based on the temperature signals.

In one embodiment, the controller further comprises a wireless transmission module in communication with an external controller from which a user is able to set up temperature parameters and time based on user's preference and/or initiate operation commands. In one embodiment, the external controller comprises a remote controller.

In one embodiment, the external controller comprises a mobile device including a smartphone, a tablet, and a laptop.

In one embodiment, the bed further comprises a cooling member coupled to the controller and configured to operably provide cooling for the mattress. In one embodiment, the cooling member comprises a plurality of fans that is individually or cooperatively controllable.

In one embodiment, the bed further comprises a frame structure; and a plurality of platforms moveably attached to the frame structure. The plurality of fans is respectively mounted onto a plurality of openings in the plurality of platforms. The mattress has a plurality of openings defined therein being operably in fluidic communication with the plurality of fans for providing air circulation to a user through the mattress, wherein the mattress is placed on the plurality of platforms, such that each opening in the mattress is directly aligned with a respective one of the plurality of fans.

In one embodiment, at least one of the plurality of fans is positioned corresponding to the back portion of the mattress, and at least one of the plurality of fans is positioned corresponding to the leg portion of the mattress.

In one embodiment, the bed further comprises a back lifting assembly and a leg lifting assembly moveably connected to the frame structure and electrically coupled with the controller, where a back portion and a leg portion of the mattress are operably in relation to the back lifting assembly and the leg lifting assembly, respectively, and positions of the back portion and the leg portion of the mattress are individually and/or coordinately adjustable in accordance with operations of the back lifting assembly and the leg lifting assembly.

In one embodiment, the back lifting assembly comprises a back lifting bracket pivotally connected to the frame structure, and a back lifting actuator pivotally connected between the back lifting bracket and the frame structure for operably driving the back lifting bracket to pivotally move in an upward rotating direction or a downward rotating direction relative to the frame structure, thereby causing a back portion of the platforms and therefore the back portion of the mattress to be lifted up or lifted down; and

In one embodiment, the leg lifting assembly comprises a leg lifting bracket pivotally coupled to the frame structure, and a leg lifting actuator pivotally connected between the leg lifting bracket and the frame structure for operably driving the leg lifting bracket to pivotally move in an upward rotating direction or a downward rotating direction relative to the frame structure, thereby causing a leg portion of the platforms and therefore the leg portion of the mattress to be lifted up or lifted down.

These and other aspects of the invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 shows schematically a bed with temperature adjustments according to embodiments of the invention.

FIGS. 2A-2C show schematically a temperature detector according to embodiments of the invention. FIG. 2A: a schematic diagram. FIG. 2B: a cross sectional view. FIG. 2C: a perspective view.

FIG. 3 show schematically a block diagram of a bed according to embodiments of the invention.

FIG. 4 shows schematically a front perspective view of a bed according to embodiments of the invention, where the bed is in an adjusted state.

FIG. 5 shows schematically a rear perspective view of the bed of FIG. 4.

FIG. 6 shows schematically another rear perspective view of the bed of FIG. 4, where the bed is in a flat state.

FIG. 7 shows schematically a bottom view of a mattress according to embodiments of the invention.

FIG. 8 shows schematically a cross-sectional view of the mattress along A-A′ shown in FIG. 6.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Furthermore, relative terms, such as “lower” or “bottom” and “upper” or “top” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising” or “includes” and/or “including” or “has” and/or “having”, or “carry” and/or “carrying,” or “contain” and/or “containing” or “involve” and/or “involving”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on”, “attached” to, “connected” to, “coupled” with, “contacting”, etc., another element, it can be directly on, attached to, electrically coupled to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

As used in this disclosure, the term “platform(s)” refers to bed platform(s), or bed board(s).

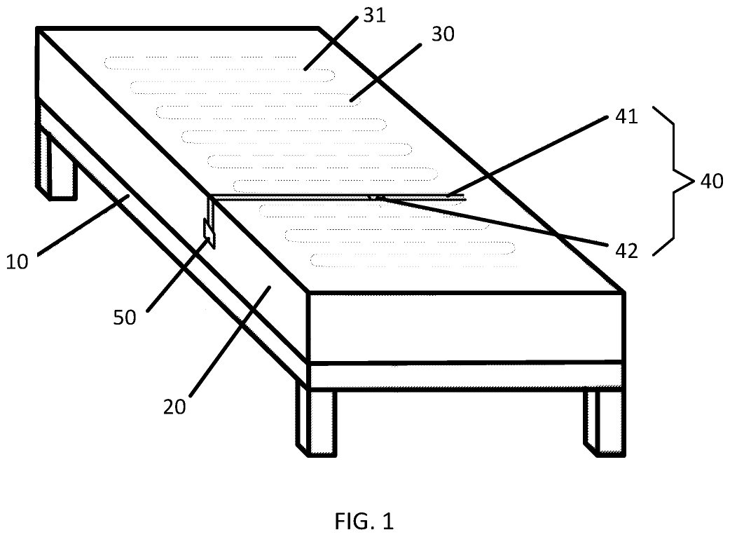

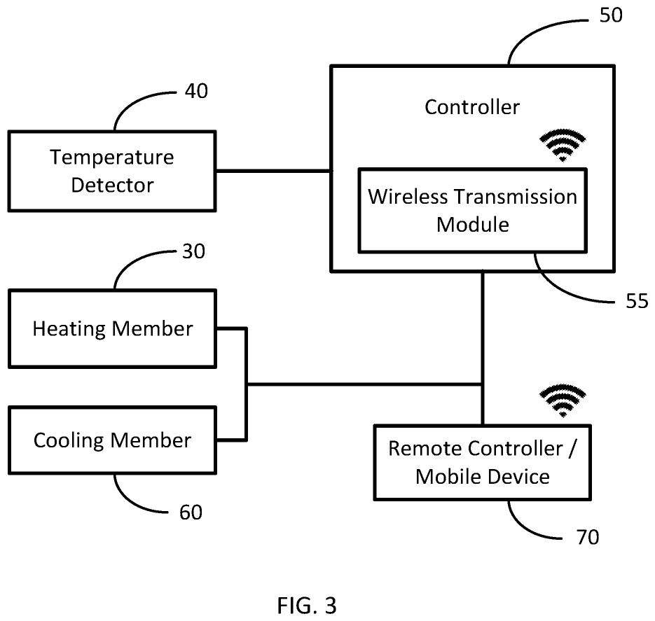

Embodiments of the invention are illustrated in detail hereinafter with reference to accompanying drawings in FIGS. 1-8. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

In accordance with the purposes of this invention, as embodied and broadly described herein, this invention, in one aspect, relates to a bed with temperature adjustment.

Referring to FIGS. 1-3, the bed in some embodiments includes a bed frame 10, and a mattress 20 disposed on the bed frame 10.

The bed also include a heating member 30 coupled to the mattress 20 and configured to operably generate heat for the mattress 20. In some embodiments, the heating member 30 comprises one or more heating wires 31 embedded in the mattress 20. In some embodiments, the one or more heating wires 31 are flexible, serpentine metal wires. It should be appreciated that other types of the heating member, such as semiconductor heating plates that can realize heating and cooling, can also be utilized to practice the invention.

The bed further include a temperature detector 40 disposed on the mattress 20 for detecting temperature of the mattress 20.

In some embodiments, the temperature detector 40 comprises one or more of thermocouples, resistance temperature detectors (RTDs), thermistors, and semiconductor based integrated circuits (IC).

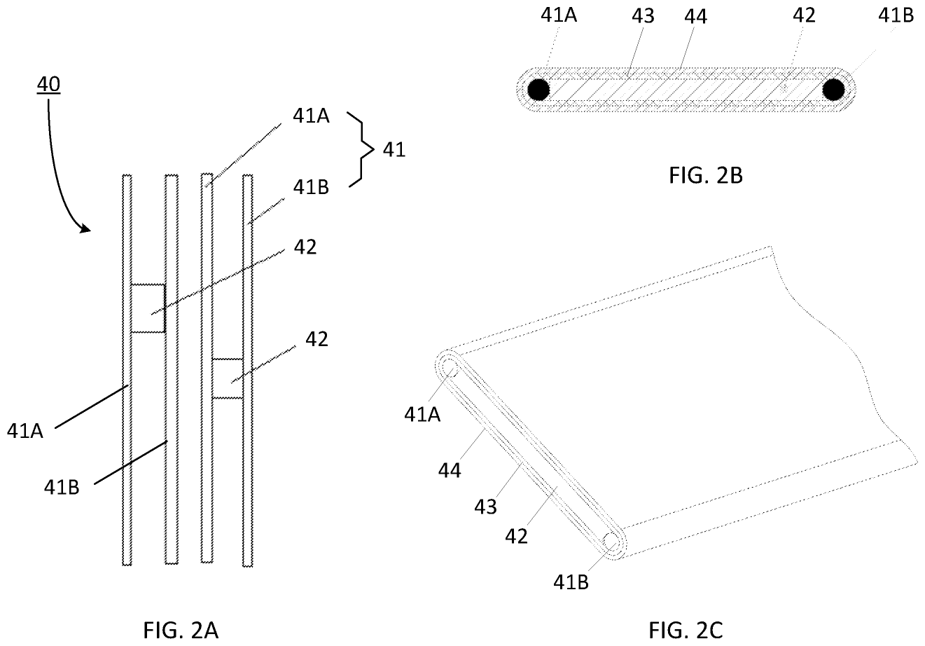

In some embodiments, as shown in FIGS. 2A-2C, the temperature detector 40 comprises a flexible ribbon or belt including a plurality of conductive wires 41A and 41B, and at least one electrical insulating layer 43 wrapping the plurality of conductive wires 41A and 41B; and a plurality of sheet-shaped temperature sensors 42. Each temperature sensor 42 is located between a pair of adjacent conductive wires 41A and 41B in the flexible ribbon and is electrically coupled to the pair of adjacent conductive wires 41A and 41B. In one embodiment, each temperature sensor 42 is arranged in the at least one electrical insulating layer 43. In addition, a cover layer 44 is also provided to cover the at least one electrical insulating layer 43. In one embodiment, the plurality of sheet-shaped temperature sensors 42 is arranged along a width direction of the mattress 20.

In one embodiment, the temperature detector 40 is assembled in a flexible ribbon, or a flexible pad.

In one embodiment, the temperature detector 40 is arranged on the surface of the mattress 20 to directly sense the surface temperature, so as to improve the accuracy of monitoring, and facilitate the controller of the bed to adjust the heating member 30, and thus the temperature of the mattress 20 is more suitable for sleep. In order to detect the surface temperature of the mattress and make it easier for the user to sleep, all the temperature sensors 42 in one embodiment are distributed along the width direction of the mattress 20. That is, the plurality of temperature sensors 42 can be arranged relative to the back of the human body. The average number of the temperature sensors 42 is used to obtain the surface temperature of the mattress 20 to improve the accuracy. In addition, if the mattress 20 is a double bed, the temperature sensors 42 are installed corresponding to where each user lies, so as to adapt to the different temperature requirements of the user. In addition, the plurality of temperature sensors can also be arranged along the length of the bed, which can be respectively arranged corresponding to the waist, back and legs of the human body, so as to realize independent temperature collection and control of each location.

The bed also has a controller 50 coupled with the heating member 30 and the temperature detector 40 and configured to receive and process signals of the temperature detected from the temperature detector 40 and control operations of the heating member 30 based on the temperature signals. In some embodiments, the controller 50 comprises a microcontroller unit (MCU) configured to receive and process signals of the temperature detected from the temperature detector and control operations of the heating member based on the temperature signals.

In some embodiments, the controller 50 further comprises a wireless transmission module 55 in communication with an external controller 70 from which a user is able to set up temperature parameters and times based on user's preference and/or initiate operation commands. The wireless transmission module 55 may communicate with the controller 50 and the external controller 70 using one or more of Bluetooth®, Near-field communication (NFC), Internet, and Cellular Data Communication protocols. In some embodiments, the external controller 70 comprises a remote controller.

In some embodiments, the external controller 70 comprises a mobile device including a smartphone, a tablet, a laptop, or the likes.

In one embodiment, the wireless transmission module 55 can transmit the detected temperature data to the remote controller, so that the remote controller can activate the heat member and other components accordingly. For example, a user can set up a desired temperature during which the use sleeps, and a sleeping duration between time when the use usually goes to the bed and time when the use usually gets up, using the remote controller, or a smart phone with an APP. Once the controller 50 receives, through the wireless transmission module 55, the setup requests of the user preferred parameters for the temperature and times, the controller 50 may process the setup requests and store the user preferred parameters. when the time approach the duration, the controller 50 activates (turns on) the temperature detector 40 to detect the temperature of the mattress 20, and activates (turns on) the heating member 30 to heat the mattress 20 if the detected temperature of the mattress 20 is lower than the desired temperature, otherwise, deactivates (turns off) the heating member 30 if the detected temperature of the mattress 20 is greater than the desired temperature. After the sleeping duration, the controller 50 turns off both the heating member 30 and the temperature detector 40, or turns off the heating member 30 and leaves the temperature detector 40 on for continuously detecting the temperature around the mattress 20. In addition, the desired temperature during which the use sleeps may be a single temperature, or multiple temperatures varied from begin, middle and end of the sleeping duration. During the sleeping duration, the temperature detector 40 is always turned on for continuously temperature monitoring. In this regard, the operation of the temperature adjustment is in a default mode.

In certain embodiments, the operation of the temperature adjustment can also be in a manual mode. For example, if the user wants to change the pre-set desired temperature to another temperature during sleeping, and/or the beginning and end times of the pre-set sleeping duration, the user can initiate such a change from the remote controller or a smartphone with the

APP. In addition, the pre-set desired temperature and sleeping duration also be changed from the remote controller or the smartphone.

Furthermore, the invention can be utilized to adjust the temperature of the bed room in which the mattress 20 is placed. For example, out of the sleeping duration, the temperature detector 40 is turned on to detect the temperature of the bed room, when the room temperature is lower than a predetermined temperature, the controller 50 activates the heating member 30 to generate heat, otherwise, when the room temperature is greater than the predetermined temperature, the controller 50 deactivates the heating member 30. Similarly, the predetermined temperature may be varied from time to time.

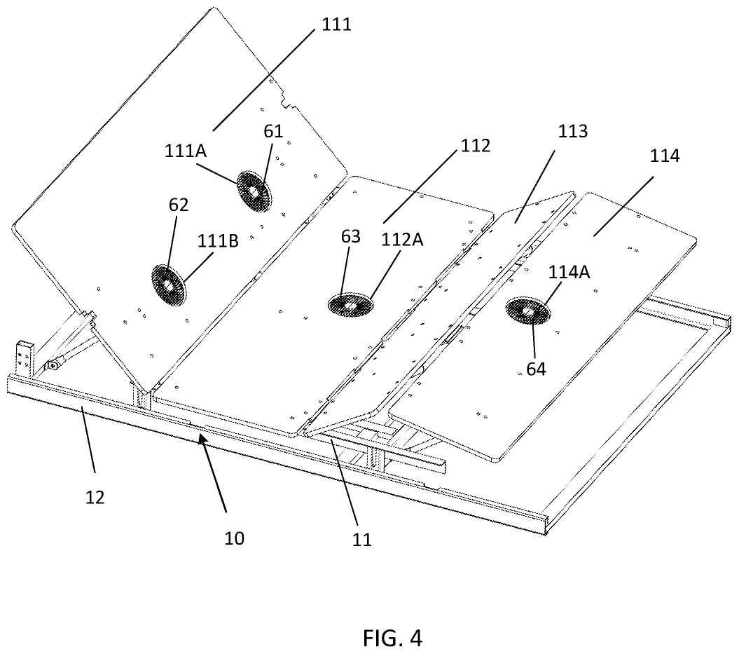

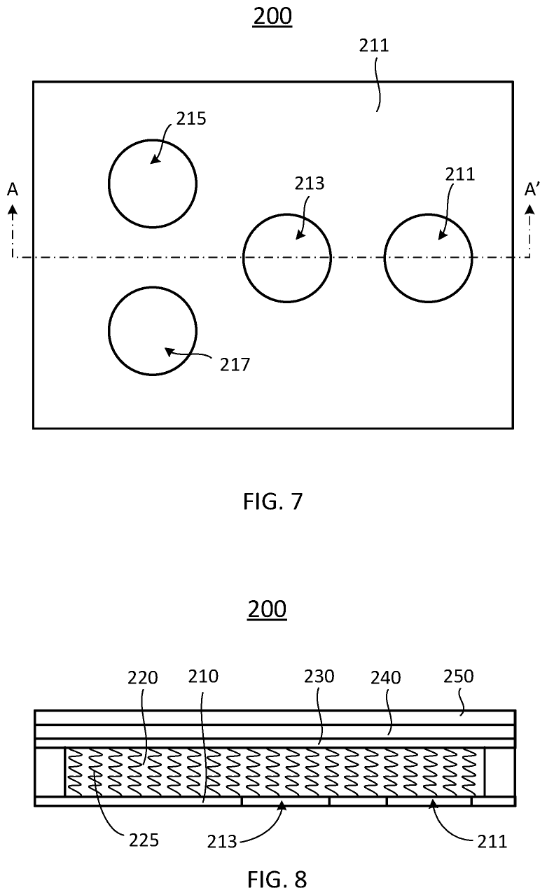

In order to better control the temperature, the bed in one embodiment is also provided with a cooling component electrically coupled to the controller. Specifically, the one or more temperature sensors are provided at the mattress corresponding to the cooling member. In one embodiment, the cooling member includes a plurality of fans installed on the bed platforms, and all fans are electrically coupled to the controller. One set of fans corresponds to the waist and leg of the human body, and the other set of fans corresponds to the back of the human body. Referring to FIGS. 4-8, the bed in some embodiments further comprises a cooling member 60, in addition to the heating member 30, the temperature detector 40 and the controller 50 shown in FIGS. 1-3. The cooling member 60 is coupled to the controller 50 and configured to operably provide cooling for the mattress 200. In one embodiment, the cooling member 60 comprises a plurality of fans 61-64 that is individually or cooperatively controllable. In one embodiment, the bed also comprises a plurality of platforms 111-114 moveably attached to the frame structure 10 (11/12). The plurality of fans 61-64 is respectively mounted onto a plurality of openings 111A, 111B, 112A and 114A in the platforms 111, 112 and 14 for example. As shown in FIGS. 7-8, the mattress 200 has a plurality of openings 211, 213, 215 and 217 defined therein being operably in fluidic communication with the plurality of fans 61-64 for providing air circulation to a user through the mattress 200. The mattress 200 is placed on the plurality of platforms 111-114, such that each opening 211/213/215/217 in the mattress 200 is directly aligned with a respective one of the plurality of fans 61-64. For example, opening 211 in the mattress 200 is directly aligned with fan 64, opening 213 in the mattress 200 is directly aligned with fan 63, opening 215 in the mattress 200 is directly aligned with fan 61, and opening 217 in the mattress 200 is directly aligned with fan 62. In some embodiments, two fans 61 and 62 are positioned corresponding to the back portion of the mattress 200, and one fan 63 is positioned corresponding to the waist portion of the mattress 200, and one fan 64 is positioned corresponding to the leg portion of the mattress 200.

Similarly, the operations of the plurality of fans 61-64 are controlled by the controller 50 based on the temperature detected by the temperature detector 40 and the desired temperature. For example, when the detected temperature is higher than the desired temperature, the controller 50 turns the fans on to provide air circulation in the mattress 200.

In some embodiments, the mattress 200 includes a knitted fabric layer, a smart foam layer, a memory foam layer, a flex comfort foam layer, a mixed support spring layer, and an elastic support foam plastic layer stacked sequentially from top to bottom. It can better cooperate with the above fans. The knitted fabric layer can enhance air circulation and breathability. The smart foam layer is breathable, flexible, and actively adapts to the natural contours of the human body. It provides all the benefits of latex, and meantime not allergic. The memory foam layer is a layer created by injecting bamboo charcoal. One can adjust humidity, smell and temperature while adapting to your body. The flex comfort foam layer adds an extra layer of comfort and creates more breathable and soft feeling, mixed support spring layer to provide breathability and thorough foundation, elastic support foam plastic layer can provide excellent performance.

The mattress 200 in one embodiment shown in FIGS. 7-8 includes a plurality of layers 210-150 vertically stacked to one another. The plurality of layers includes a first layer 210, a second layer 220 disposed on the first layer 210, a third layer 230 disposed on the second layer 220, a fourth layer 240 disposed on the third layer 230; and a fifth layer 250 disposed on the fourth layer 240. The first layer 210 comprises four openings 211, 213, 215 and 117 defined in the first layer 210. The openings 211, 213, 215 and 117 are operably in fluidic communication with a plurality of fans 60 for providing air circulation to a user through the mattress 200. It should be noted that other number of openings can also be utilized to practice the invention. In one embodiment, the heating member 30 may be disposed in any one of the third layer 230, the fourth layer 240, and the fifth layer 250.

In some embodiments, the first layer 210 is formed of a flex support foam for providing corner to corner support, and ensuring a deeper, more regenerative night's sleep. The second layer 220 is arranged between the first layer 210 and the third layer 230 and comprises an array of springs 225. The array of springs comprises a specially fitted hybrid support-springs to provide breathable, ventilation and thorough foundation. In some embodiments, the array of springs comprises a plurality of pocket springs or coil springs. The third layer 230 is formed of a flex comfort foam, which adds an additional layer of comfort to create a more breathable and supple feel. The fourth layer 240 is formed of a ventilated bamboo charcoal memory foam. The ventilated bamboo charcoal memory foam comprises a memory foam infused with bamboo charcoal, for regulating moisture, odor and/or temperature, and adapting to user body's individual points. The fifth layer 250 is formed of a smart foam that is breathable, flexible and operably adapts to user body's natural contours. It also provides all of the benefits of the latex whilst being allergy free.

In some embodiments, the bed further comprises a back lifting assembly 120 and a leg lifting assembly 130 moveably connected to the frame structure 10 and electrically coupled with the controller 50, where a back portion and a leg portion of the mattress 200 are operably in relation to the back lifting assembly 120 and the leg lifting assembly 130, respectively, and positions of the back portion and the leg portion of the mattress 200 are individually and/or coordinately adjustable in accordance with operations of the back lifting assembly 120 and the leg lifting assembly 130.

As shown in FIGS. 4-6, the frame structure 10 in one embodiment includes a first bed support 11 and a second bed support 12 supporting the first bed support 11. Both of the first bed support 21 and the second bed support 22 are composed of horizontal rails/rods and vertical rails/rods. With a rectangular parallelepiped frame structure, and the size of the second bed support 12 is larger than the size of the first bed support 11, and the first bed support 11 and the second bed support 12 are movably matched. A plurality of bed platforms 111, 112, 113, 114 are sequentially disposed on the first bed support 11. Each adjacent bed platforms/boards are hinged by a hinge, and the bed board 112 corresponding to the waist is fixed between the first bed support 11. All the rest of the bed boards are supported on the first bed support 11, and are not directly coupled with the first bed support 11.

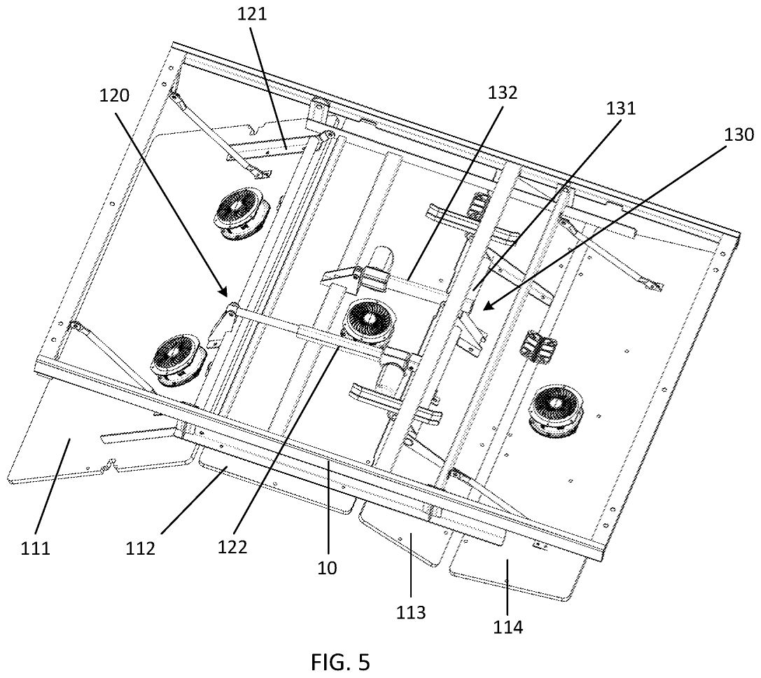

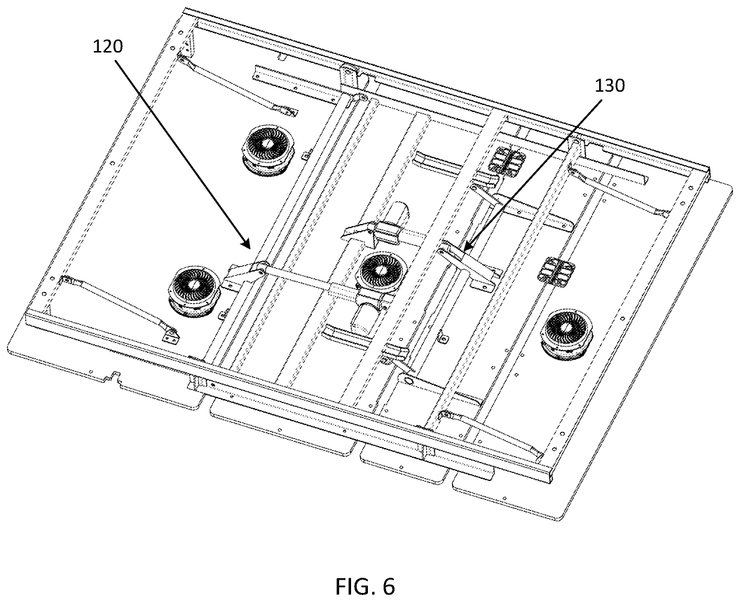

As shown in FIGS. 5-6, in one embodiment, the back lifting assembly 120 comprises a back lifting bracket 121 pivotally connected to the frame structure 10, and a back lifting actuator 122 pivotally connected between the back lifting bracket 121 and the frame structure 10 for operably driving the back lifting bracket 121 to pivotally move in an upward rotating direction or a downward rotating direction relative to the frame structure 10, thereby causing a back portion 111 of the platforms and therefore the back portion of the mattress 200 to be lifted up or lifted down.

The leg lifting assembly 130 comprises a leg lifting bracket 131 pivotally coupled to the frame structure 10, and a leg lifting actuator 132 pivotally connected between the leg lifting bracket 131 and the frame structure 10 for operably driving the leg lifting bracket 131 to pivotally move in an upward rotating direction or a downward rotating direction relative to the frame structure 10, thereby causing a leg portion 114 of the platforms and therefore the leg portion of the mattress 200 to be lifted up or lifted down.

Accordingly, the bed of the invention can provide temperature adjustments and position adjustments at user's preference so that the user achieves maximum comfort when using the bed. The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A bed, comprising:
a mattress;
a heating member coupled to the mattress and configured to operably generate heat for the mattress;
a temperature detector disposed on the mattress for detecting temperature of the mattress; and
a controller coupled with the heating member and the temperature detector and configured to receive and process signals of the temperature detected from the temperature detector and control operations of the heating member based on the temperature signals.

2. The bed of claim 1, wherein the heating member comprises one or more heating wires embedded in the mattress.

3. The bed of claim 2, wherein the one or more heating wires are flexible, serpentine metal wires.

4. The bed of claim 1, wherein the temperature detector comprises one or more of thermocouples, RTDs resistance temperature detectors (RTDs), thermistors, and semiconductor based integrated circuits (IC).

5. The bed of claim 4, wherein the temperature detector comprises:
a flexible ribbon including a plurality of conductive wires and at least one electrical insulating layer wrapping each of the plurality of conductive wires; and
a plurality of sheet-shaped temperature sensors, wherein each temperature sensor is located between a pair of adjacent conductive wires in the flexible ribbon and is electrically coupled to the pair of adjacent conductive wires.

6. The bed of claim 5, wherein each temperature sensor is arranged in the at least one electrical insulating layer.

7. The bed of claim 5, wherein the plurality of sheet-shaped temperature sensors is arranged along a width direction of the mattress.

8. The bed of claim 1, wherein the temperature detector is assembled in a flexible ribbon, or a flexible pad.

9. The bed of claim 1, wherein the controller comprises a microcontroller unit (MCU) configured to receive and process signals of the temperature detected from the temperature detector and control operations of the heating member based on the temperature signals.

10. The bed of claim 9, wherein the controller further comprises a wireless transmission module in communication with an external controller from which a user is able to set up temperature parameters and time based on user's preference and/or initiate operation commands.

11. The bed of claim 10, wherein the external controller comprises a remote controller.

12. The bed of claim 10, wherein the external controller comprises a mobile device including a smartphone, a tablet, or a laptop.

13. The bed of claim 1, further comprising a cooling member coupled to the controller and configured to operably provide cooling for the mattress.

14. The bed of claim 13, wherein the cooling member comprises a plurality of fans that is individually or cooperatively controllable.

15. The bed of claim 14, further comprising:
a frame structure; and
a plurality of platforms moveably attached to the frame structure,
wherein the plurality of fans is respectively mounted onto a plurality of openings in the plurality of platforms; and
wherein the mattress has a plurality of openings defined therein being operably in fluidic communication with the plurality of fans for providing air circulation to a user through the mattress, wherein the mattress is placed on the plurality of platforms, such that each opening in the mattress is directly aligned with a respective one of the plurality of fans.

16. The bed of claim 15, wherein at least one of the plurality of fans is positioned corresponding to the back portion of the mattress, and at least one of the plurality of fans is positioned corresponding to the leg portion of the mattress.

17. The bed of claim 15, further comprising a back lifting assembly and a leg lifting assembly moveably connected to the frame structure and electrically coupled with the controller, wherein a back portion and a leg portion of the mattress are operably in relation to the back lifting assembly and the leg lifting assembly, respectively, and positions of the back portion and the leg portion of the mattress are individually and/or coordinately adjustable in accordance with operations of the back lifting assembly and the leg lifting assembly.

18. The bed of claim 17,
wherein the back lifting assembly comprises a back lifting bracket pivotally connected to the frame structure, and a back lifting actuator pivotally connected between the back lifting bracket and the frame structure for operably driving the back lifting bracket to pivotally move in an upward rotating direction or a downward rotating direction relative to the frame structure, thereby causing a back portion of the platforms and therefore the back portion of the mattress to be lifted up or lifted down; and
wherein the leg lifting assembly comprises a leg lifting bracket pivotally coupled to the frame structure, and a leg lifting actuator pivotally connected between the leg lifting bracket and the frame structure for operably driving the leg lifting bracket to pivotally move in an upward rotating direction or a downward rotating direction relative to the frame structure, thereby causing a leg portion of the platforms and therefore the leg portion of the mattress to be lifted up or lifted down.
